(19) United States
(12) Patent Application Publication
(10) Pub. No.: US 2003/0210460 A1
(43) Pub. Date: Nov. 13, 2003

(54) Microscope stage and microscope having microscope stage mounted thereon

(75) Inventor: Yasuteru Takahama, Kodaira-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/397,798

(22) Filed: Mar. 26, 2003

(30) Foreign Application Priority Data
Mar. 27, 2002 (JP) 2002-089471

(51) Int. Cl. G02B 21/26

(52) U.S. Cl. 359/391

(57) ABSTRACT

There is provided a microscope stage comprising a substrate whose position is adjustable in a plane orthogonal to a optical axis of an objective lens, an upper plate which mounts an observation sample and is movable in a two-dimensional direction, and a movement restricting member which is provided between the substrate and the upper plate and restricts movement of the upper plate to two directions on the plane orthogonal to the optical axis of the objective lens.

### CROSS-REFERENCE TO RELATED APPLICATIONS

This application is based upon and claims the benefit of priority from the prior Japanese Patent Application No. 2002-089471, filed Mar. 27, 2002, the entire contents of which are incorporated herein by reference.

### BACKGROUND OF THE INVENTION

1. Field of the Invention

The present invention relates to a microscope stage on which an observation sample is mounted, and a microscope having the microscope stage mounted thereon.

2. Description of the Related Art

For example, in cases where a sample such as a constitution specimen, a mineral specimen and an organism specimen is observed by using an optical microscope such as a polarizing microscope or an inverted microscope, a so-called rotary stage may be used as a microscope stage on which such an observation sample is mounted in order to examine a polarization characteristic obtained due to a difference in orientation of the observation sample or perform desired framing by changing the orientation of the sample relative to an image recording apparatus.

In such a rotary stage, the following functions are required in order to prevent the observation sample from being invisible from an observation field. First, the center of rotation is matched with an optical axis of an objective lens of the microscope, and the center of the observation field which is currently seen is determined as the center of rotation (some rotary stages are configured that matching is achieved in advance). Then, an arbitrary position of the observation sample to be observed is moved to the vicinity of the center of rotation.

Jpn. Pat. Appln. KOKAI Publication No. 60-88919 discloses that, in a microscope stage used to adjust a sample position in a polarizing microscope, a slide glass holder and a slide glass presser which are orthogonal to each other are arranged on a discoid stage which has an angle indicating scale provided in the vicinity of a circumferential portion thereof and can rotate without restraint, and movement of a sample on a slide glass can be adjusted by these members so that the sample can enter a observation field of the microscope.

Further, Jpn. Pat. Appln. KOKAI Publication No. 7-56093 discloses that, in a stage of a microscope which enables pivoting and inclination of an XY axis movable stage, a rotary table capable of pivoting is provided on a base, and the XY axis movable stage is supported on the rotary table by three support pin members capable of adjusting an amount of upward protrusion, thereby adjusting pivoting and inclination of the XY axis movable stage.

### BRIEF SUMMARY OF THE INVENTION

According to an aspect of the present invention, there is provided a microscope stage comprising: a substrate whose position is adjustable in a plane orthogonal to a optical axis of an objective lens; an upper plate which mounts an observation sample and is movable in a two-dimensional direction on the substrate; and a movement restricting member which is provided between the substrate and the upper plate and restricts movement of the upper plate to two directions on a plane orthogonal to the optical axis of the objective lens.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a schematic configuration of an inverted metallographical microscope according to a first embodiment of the present invention;

FIGS. 2A and 2B are views showing a schematic configuration of a microscope stage to which the first embodiment is applied;

FIGS. 3A to 3D are views for explaining configurations of a rotary plate, a ring-shaped member and an upper plate used in the first embodiment;

FIG. 4 is a view showing a schematic configuration of a rotary clamp mechanism used in the first embodiment;

FIGS. 5A to 5D are views showing a modification of the first embodiment;

FIGS. 6A to 6E are views showing another modification of the first embodiment;

FIGS. 7A to 7B are views showing a schematic configuration of a microscope stage to which the second embodiment according to the present invention is applied;

FIG. 8 is a view showing a schematic configuration of first and second driving mechanisms used in the second embodiment;

FIGS. 9A and 9B are views showing a schematic configuration of a microscope stage to which the third embodiment according to the present invention is applied;

FIG. 10 is a view showing a schematic configuration of first and second driving mechanisms used in the third embodiment; and

FIG. 11 is a view showing a schematic configuration when the microscope stage in each embodiment according to the present invention is applied to a microscope with upright frame.

### DETAILED DESCRIPTION OF THE INVENTION

Preferred embodiments according to the present invention will be described hereinafter with reference to the accompanying drawings.

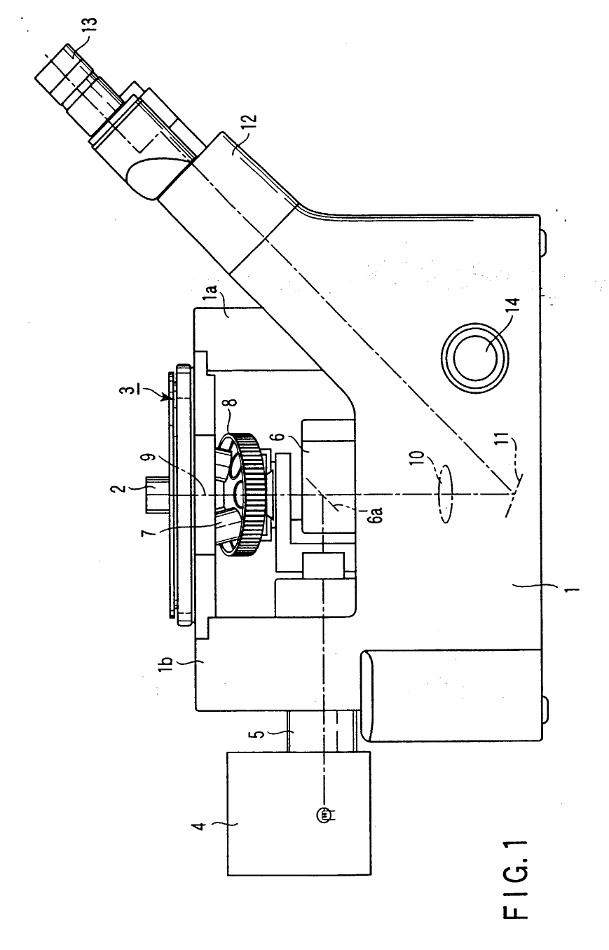

FIG. 1 is a view showing a schematic configuration of an inverted metallographical microscope to which a first embodiment according to the present invention is applied.

In FIG. 1, a microscope main body (referred to as a “main body”, hereinafter) 1 has a substantially U shape, and has a front side fixed part 1a and a rear side fixed part 1b which are referred to as mirror legs and protrude to the upper side on front and rear sides thereof. A microscope stage 3 having an observation sample 2 mounted thereon is provided on the front side fixed part 1a and the rear side fixed part 1b.

A light flux from an incident-light illumination light source 4 such as a halogen lamp or mercury is led to a mirror unit 6 through an incident-light illuminator 5, reflected by a half mirror 6a provided in the mirror unit 6, and radiated on an observation surface (lower surface) of the observation sample 2 through objective lenses 7. In this case, a plurality of objective lenses 7 are held in a revolver 8 and selectively arranged on an optical axis 9.

The reflected light from the observation sample 2 is transmitted through the half mirror 6a, and an enlarged image of the observation sample 2 is formed by an image forming lens 10 together with the objective lenses 7. The light is reflected to the upper oblique direction by a reflection mirror 11, relayed by a non-illustrated relay optical system, then enters an eyepiece 13 through an observation tube 12, and reaches eyes of an observer, thereby being observed.

The revolver 8 holding a plurality of the objective lenses 7 is held in the main body 1 by a non-illustrated holding part. The revolver 8 is moved up and down along the optical axis 9 by manipulation of a sighting handle 14 and a relative distance between the observation sample 2 on the microscope stage 3 and the objective lens 7 is varied, thereby enabling focusing on the observation sample 2. Furthermore, the observation tube 12 is attached to the front side upper part of the main body 1, and the eyepiece 13 is attached to a binocular portion of the observation tube 12.

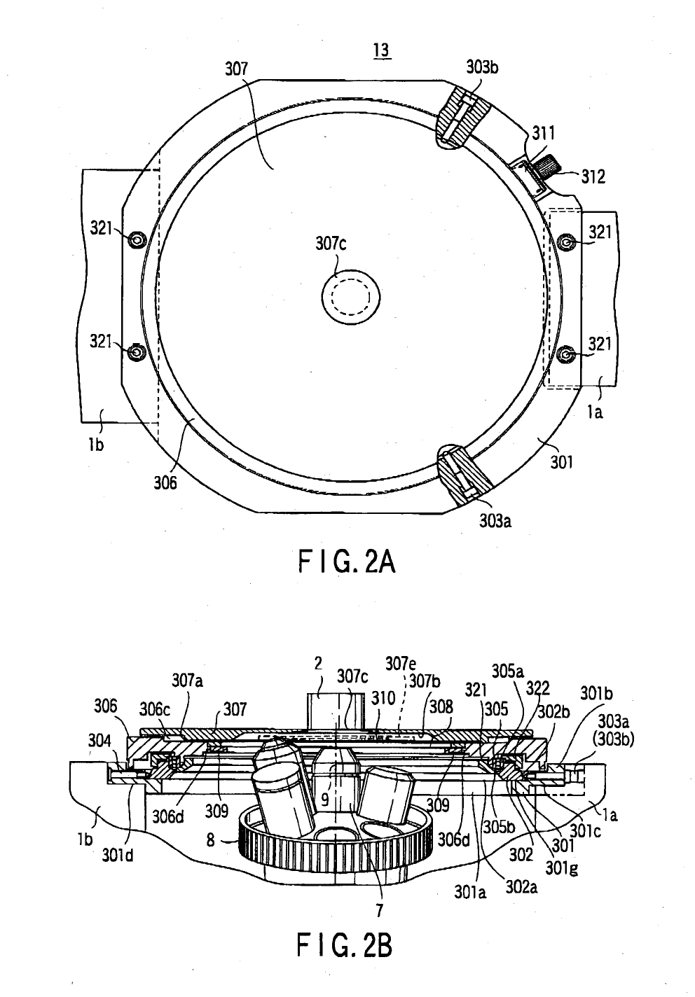

FIGS. 2A and 2B are views showing a schematic configuration of the microscope stage 3. FIG. 2A is a view showing the microscope stage 3 from the upper surface, and FIG. 2B is a sectional side elevation of the microscope stage 3.

In FIGS. 2A and 2B, an opening 301a corresponding to a movement range required for switching of the objective lenses 7 is formed at a central part of a discoid stage receiver 301. Moreover, a thick part 301b is formed on the outer peripheral portion of the stage receiver 301. Attachment surfaces 301c and 301d are formed on the lower surface of the thick part 301b on the outer peripheral portion of the stage receiver 301 at positions opposed to each other with a central point therebetween. When the attachment surfaces 301c and 301d are mounted on the front side fixed part 1a and the rear side fixed part 1b and fastened by bolts 321, the stage receiver 301 is fixed between the front side fixed part 1a and the rear side fixed part 1b. Moreover, a flat surface portion 301g is formed on the upper surface side of the thick part 301b on the outer peripheral portion of the stage receiver 301 through a step portion along a rim of the opening 301a.

On the flat surface portion 301g on the rim of the opening 301a of the stage receiver 301 is mounted a substrate 302 so as to be capable of centering with respect to the stage receiver 301. The substrate 302 is configured to be capable of adjusting a position in a plane orthogonal to the optical axis 9 of the objective lens 7, and to the substrate 302 are formed an opening 302a whose dimension is substantially the same as the opening 301a of the stage receiver 301 and a tapered portion 302b on the outer peripheral surface thereof.

Two centering screws 303a and 303b and one plunger 304 are arranged to the outer peripheral portion of the stage receiver 301 along the circumferential direction at substantially equal intervals. The centering screws 303a and 303b and the plunger 304 pierce the thick part 301b of the stage receiver 301 and their tips are brought into contact with the tapered portion 302b of the substrate 302. Centering of the substrate 302 is carried out by pushing the tapered portion 302b by using the centering screws 303a and 303b, and the substrate 302 is prevented from moving at a predetermined position by using the plunger 304 in cooperation with the centering screws 303a and 303b.

On the substrate 302 is arranged a rotary plate 306 having formed at the center thereto an opening 306a which communicates with the opening 302a of the substrate 302. In this case, an outer ring 305a of a radial bearing 305 is fixed on the inner surface of the opening 302a of the substrate 302 by a fixing ring 322, and the rotary plate 306 is fixed to an inner ring 305b of the radial bearing 305 by a fixing ring 323 so that the rotary plate 306 is rotatably supported with the center of the substrate 302 as the center of rotation.

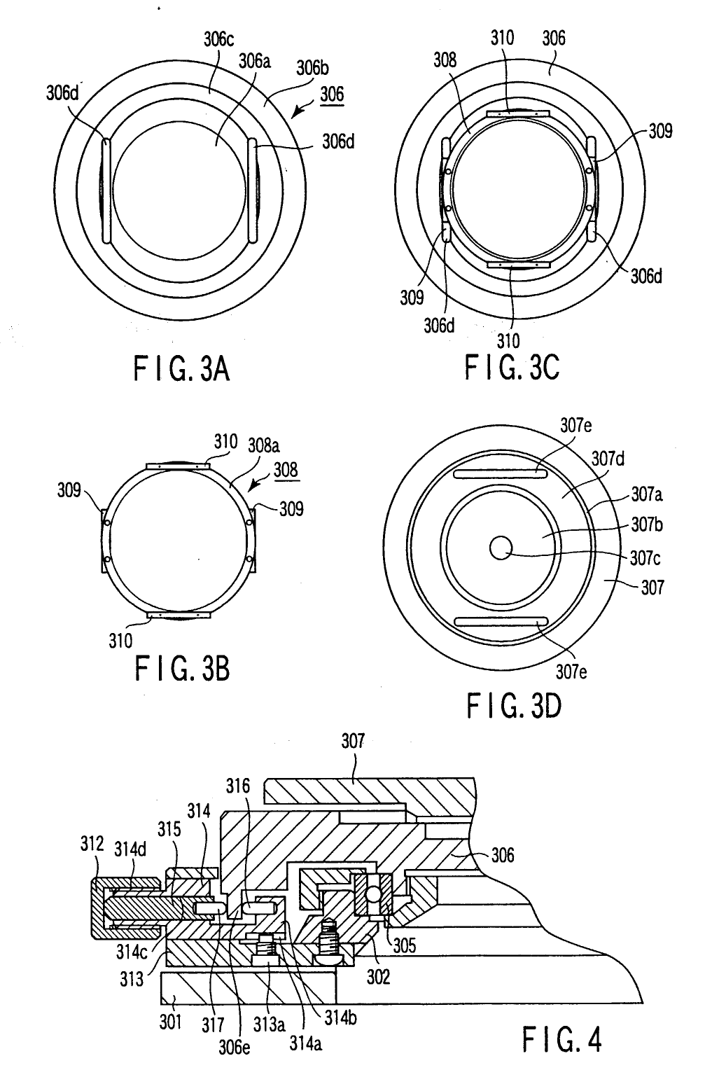

A protruding wall 306b is formed to the rotary plate 306 along the outer rim portion on the upper surface as shown in FIG. 3A, and parallel guide grooves 306d are provided on the flat surface 306c between the protruding wall 306b and the rim of the opening 306a and a flat surface which is lower than the flat surface 306c by one step along the vertical direction of the page space with the opening 306a therebetween.

An upper plate 307 is arranged on the rotary plate 306 through a ring-shaped member 308 as a movement restricting member.

A pair of guide members 309 corresponding to the parallel guide grooves 306d of the rotary plate 306 are provided to the ring-shaped member 308 on one surface of the ring-shaped main body 308 as shown in FIG. 3B. A pair of the guide members 309 are inserted into the parallel guide grooves 306d of the rotary plate 306 as shown in FIG. 3C. The ring-shaped member 308 can linearly reciprocate along the guide grooves 306d in a state that the guide members 309 are inserted in the guide grooves 306d. Further, a pair of guide members 310 corresponding to parallel guide grooves 307e on a later-described upper plate 307 are provided on the other surface of the ring-shaped main body 308a in a direction orthogonal to a pair of the guide members 309.

A protruding portion 307a which can slide on the flat surface 306c of the rotary plate 306 along the outer rim portion of the lower surface is formed to the upper plate 307 so that the upper plate 307 can move on the rotary plate 306 in the two-dimensional direction. Furthermore, a concave portion 307b is formed at the central part on the lower surface, and a small opening 307c used to observe a sample is formed at the center of this concave portion 307b. Moreover, parallel guide grooves 307e formed along the horizontal direction of the page space with the concave portion 307b therebetween are provided to the upper plate 307 on a flat surface 307d between the protruding portion 307a and the rim of the concave portion 307b as shown in FIG. 3D.

With such an upper plate 307 being arranged on the rotary plate 306, a pair of the guide members 310 provided on the other surface of the ring-shaped main body 308a are inserted into the guide grooves 307e, and the entire upper plate 307 can linearly reciprocate along the pair of the guide members 310.

That is, as to the relationship between the rotary plate 306, the ring-shaped member 308 and the upper plate 307, the ring-shaped member 308 is provided so as to be capable of linearly reciprocating along only the guide grooves 306d with respect to the rotary plate 306, and the upper plate 307 can linearly reciprocate along the pair of the guide members 310 in a direction orthogonal to a movement direction of the ring-shaped member 308 with respect to the ring-shaped member 308.

In addition, a lubricant such as a grease is applied between the flat surface 306c of the rotary plate and the protruding portion 307a of the upper plate 307 which is caused to slide on the flat surface 306c in order to smoothen the movement therebetween.

Therefore, with such an arrangement, when the upper plate 307 is pushed in an arbitrary direction in a plane orthogonal to the optical axis 9 of the objective lens 7, the upper plate 307 can move in the XY direction without changing a relative angle with respect to the rotary plate 306. In this case, since a lubricant such as a grease is applied to the sliding parts of the upper plate 307 and the rotary portion 306, the upper plate 307 can slide with respect to the rotary plate 306 with an appropriate amount of force.

In addition, each of the opening 306a at the center of the rotary plate 306 and the ring-shaped member 308 is configured to have a large aperture diameter, and the objective lens 7 does not interfere when the revolver 8 is rotated in order to change a magnification. Additionally, since the concave portion 307b is formed on the lower surface (opposite side to the surface on which the observation sample 2 is mounted) of the upper plate 307 in a large range with the small opening 307c for observation at the center and the upper plate 307 is thereby configured to have a small wall thickness, the objective lens 7 is likewise prevented from interfering when the revolver 8 is rotated.

Again referring to FIGS. 2A and 2B, a vernier scale 311 is provided to the substrate 302. The vernier scale 311 can be used to read a rotation angle of the rotary plate 306 relative to the substrate 302 in cooperation with the scale provided to the outer periphery of the rotary plate 306. A rotary clamp knob 312 is supported on the vernier scale 311. The rotary clamp knob 312 fixes the rotary plate 306 so as to avoid rotation of the rotary plate 306 with respect to the substrate 302 by a fastening operation.

The rotary clamp mechanism including such a rotary clamp knob 312 will now be described with reference to FIG. 4. FIG. 4 is a cross-sectional view showing a surface including the rotary clamp knob 312, and like reference numerals denote parts equal to those in FIG. 2.

In this case, a scale base 313 is fixed to the substrate 302. A pin 313a is implanted in the memory base 313. A clamp base 314 is arranged on the scale base 313. A long groove 314a is formed to the clamp base 314 along the radial direction of the rotary plate 306 (i.e., the right-and-left direction of the page space), and a tip of the pin 313a is inserted into the long groove 314a so that the entire clamp base 314 can move in the right-and-left direction of the page space (radial direction of the rotary plate 306).

A protruding wall 314b is formed to the clamp base 314 at the end portion thereof in the movement direction of the clamp base 314. Also, a long hole 314c is formed along the radial direction, and a clamp shaft 315 is inserted into the long hole 314c so as to be capable of moving in the right-and-left direction of the page space (radial direction of the rotary plate 306).

Clamp pins 316 and 317 are attached to the protruding wall 314b of the clamp base 314 and a tip of the clamp shaft 315, respectively. The clamp pins 316 and 317 are arranged in a direction along which a thin part 306e formed along the outer rim portion on the lower surface of the rotary plate 306 is sandwiched. In this case, the thin part 306e of the rotary plate 306 is sandwiched between the clamp pins 316 and 317 by movement of the clamp shaft 315 in the right direction in the drawing, thereby restricting rotation of the rotary plate 306.

A screw portion 314d is formed to the clamp base 314, and the above-described clamp knob 312 is screwed to the screw portion 314d. When the clamp knob 312 is fastened in this state, the clamp shaft 315 is relatively pushed in the direction of the center of the optical axis of the objective lens 7 with respect to the clamp base 314, and the thin part 306e of the rotary plate 306 is thereby sandwiched between the two clamp pins 316 and 317, thus fixing rotation of the rotary plate 306.

According to the rotary clamp mechanism configured as mentioned above, since rotation of the rotary plate 306 can be fixed by only sandwiching the rotary plate 306 between the two clamp pins 316 and 317 without pushing the rotary plate 306 in the direction of the optical axis center of the objective lens 7, it is possible to avoid a problem that an image of the observation sample 2 moves in a observation field when the rotary clamp knob 312 is fastened.

According to the first embodiment, when the observation sample 2 is observed, the revolver 8 is first rotated, the objective lens 7 with a low magnification selected from a plurality of the objective lenses 7 is set on the optical axis 9, and the observation sample 2 is focused by the manipulation of the sighting handle 14. Then, how an image of the observation sample 2 moves in the observation field of the eyepiece 13 is observed by rotating the rotary plate 306. At this moment, the two centering screws 303a and 303b are rotated in such a manner that the image of the observation sample 2 rotates around the vicinity of the center of the observation field, thereby centering the substrate 302.

Upon completion of adjustment to match the center of rotation of the image of the observation sample 2 with the center of the observation field, the upper plate 307 is then slid on the rotary plate 306 in the XY direction, a target observation position in the observation sample 2 is substantially placed in the observation field, and the objective lens 7 having a target higher magnification selected from a plurality of the objective lenses 7 is set on the optical axis 9 by rotating the revolver 8. Subsequently, after performing fine adjustment of focus by the operation of the sighting handle 14, the direction of the observation sample 2 is adjusted to a desired direction by rotating the rotary plate 306. When the direction of the observation sample 2 is determined, the rotary clamp knob 312 is fastened to fix the rotary plate 306 so as to avoid rotation.

At last, the upper plate 307 is again slid on the rotary plate 306 in the XY direction, and fine adjustment is applied to a position of the observation sample 2 so as to obtain an optimum observation range.

When observation of one target position in the observation sample 2 is finished by such a procedure, the upper plate 307 is again slid on the rotary plate 306 in the XY direction, and the observation position is changed. In this case, if the observation position to be changed in the observation sample 2 is relatively close to the first observation position, the observation position can be changed without varying the magnification of the objective lens 7. However, when changing to a position distanced from the first observation position, it is necessary to change the objective lens 7 to one with a low magnification and then slide the upper plate 307 on the rotary plate 306 in the XY direction and move it to the vicinity of the observation position. Thereafter, the objective lens 7 must be changed to one having a target magnification, and the upper plate 307 must be finely adjusted in order to obtain a target observation range.

It is to be noted that the direction of the observation sample 2 is changed or finely adjusted by rotating the rotary plate 306 when the observation sample 2 having the polarization property is observed by the polarizing observation method, when the framing is changed in case of the photography or when a polishing damage obtained during manufacture of the sample is made indistinctive in an observation image. In this case, fine adjustment by sliding of the upper plate 307 carried out in order to change the observation position of the observation sample 2 like this embodiment is performed while maintaining a predetermined angle set by rotation of the rotary plate 306, and the direction of the observation sample 2 is not varied, which is very convenient. Additionally, since the direction of the observation sample 2 is uniquely determined by an angle of the rotary plate 306, storing the rotation angle read by the vernier scale 311 enables the observation sample 2 to be always observed in the same direction by restoring the stored angle, thereby considerably improving the operability.

Therefore, according to the inverted metallographical microscope having such a configuration, it is possible to obtain a stable observation image which hardly causes a partial blur even if the observation sample is a constitution sample or a large sample having a great mass. Further, the substrate 302 is arranged as the microscope stage so as to be capable of being centered with respect to the stage receiver 301, the rotatable rotary plate 306 is arranged on the substrate 302, and the upper plate 307 capable of moving in the XY direction is arranged through the ring-shaped member 308, which results in a compact configuration minimizing a space of the objective lens 7 in the optical axis direction. Therefore, the microscope stage can be optimally combined with an inverted microscope having a large restriction in a dimension of the stage in the thickness direction.

Furthermore, each of the opening 306a at the center of the rotary plate 306 and the ring-shaped member 308 is configured to have a large aperture diameter, and the lower surface of the upper plate 307 also has the concave portion 307 formed thereto in a large range with the small opening 307 for observation at the center and is configured to be thin. Thus, when the revolver 8 is rotated in order to change the magnification, it is possible to assuredly eliminate the problem that the objective lens 7 interferes.

Moreover, in regard to adjustment of the observation position of the observation sample 2, since the point to be observed in the observation sample 2 can be moved into the observation field by moving the upper plate 307 in the XY direction while maintaining an angle set by rotation of the rotary plate 306, observation can be continued without changing the direction of the observation sample 2, thereby considerably improving the operability of the stage.

In addition, since the clamp mechanism which fixes rotation of the rotary plate 306 is provided, the direction (rotating direction) of the sample is not accidentally changed when adjusting the observation position of the observation sample 2, thus constantly enabling sample observation in the stable state.

It is to be noted that a pair of the guide members 309 and a pair of the guide members 310 are used in the first embodiment, but the number of each of these members may be one.

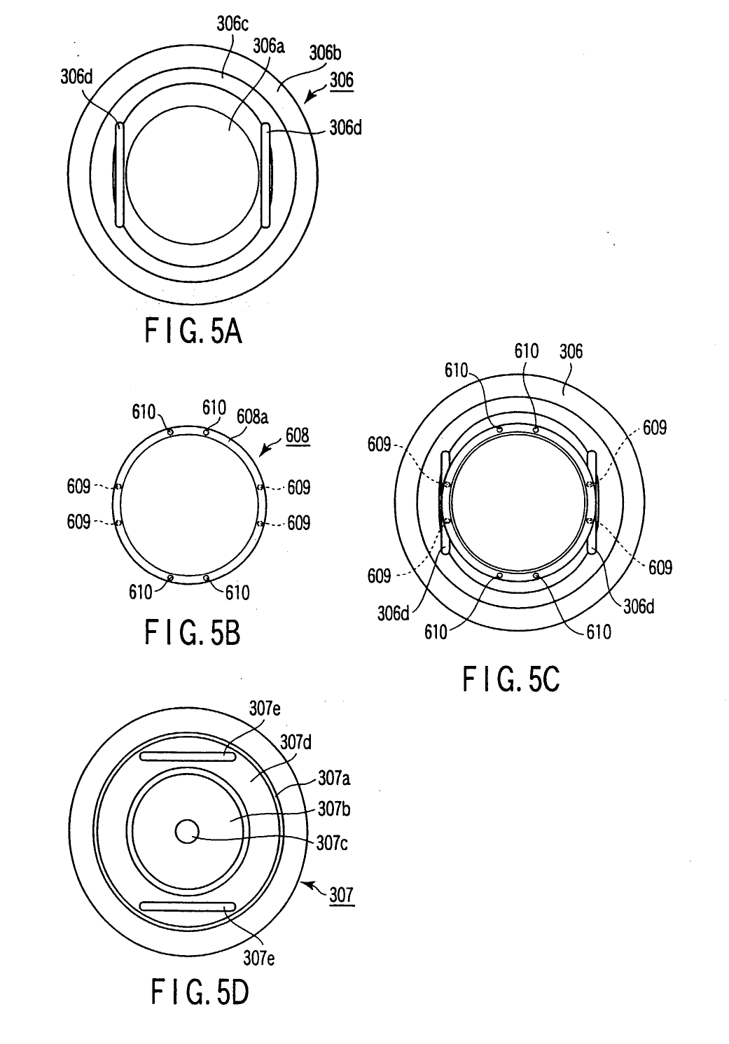

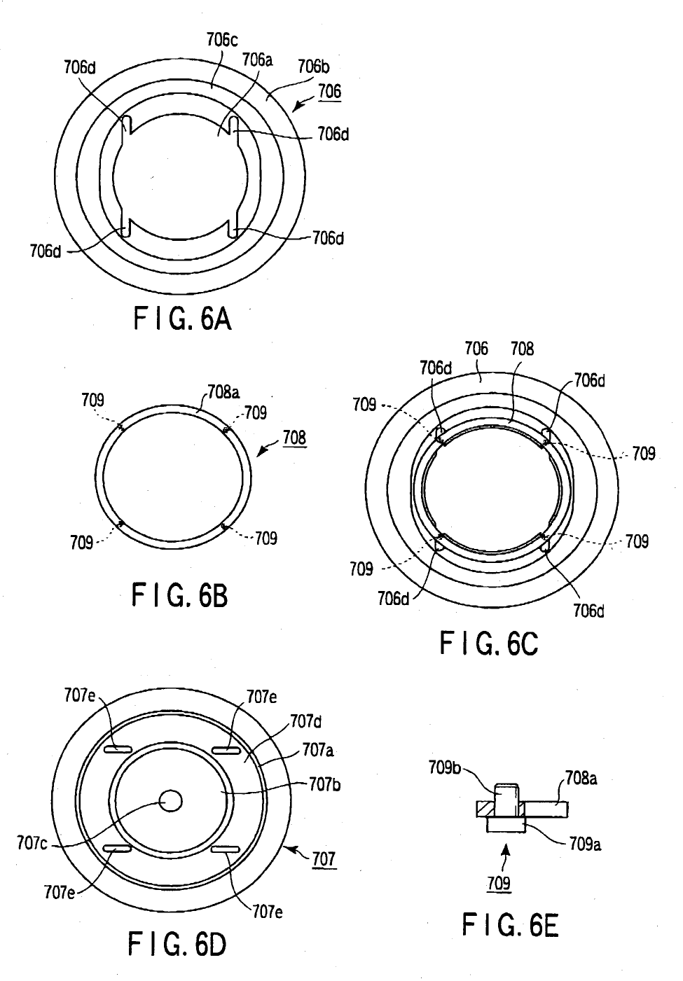

Description will now be given as to modifications of the ring-shaped member 308 as a movement restricting member, a pair of the guide members 309 and a pair of the guide members 310 shown in FIG. 3 with reference to FIGS. 5A to 5D and FIGS. 6A to 6E. Incidentally, in case of the modification shown in FIGS. 6A to 6E, shapes of the rotary plate 306 and the upper plate 307 are slightly different from those in the first embodiment, and hence the shapes will be also described.

FIGS. 5A to 5D illustrate a modification of only the ring-shaped member 308, a pair of the guide members 309 and a pair of the guide members 310, and the rotary plate 306 and the upper plate 307 are equal to those depicted in FIG. 3.

As a component corresponding to the ring-shaped member 306 in FIG. 3, a ring-shaped member 608 is arranged on the rotary plate 306.

Four pins 609, two of which are provided on one side and remaining two of which are provided on the other side, corresponding to the parallel guide grooves 306d of the rotary plate 306 are provided to the ring-shaped member 608 on one surface of a ring-shaped member main body 608a.

These four pins 609 are inserted into the parallel guide grooves 306d of the rotary plate 306 as shown in FIG. 5C, and the ring-shaped member 608 can linearly reciprocate along the guide grooves 306d in this state.

Furthermore, four pins 610, two of which are provided on one side and remaining two of which are provided on the other side, corresponding to the later-described parallel grooves 307e of the upper plate 307 are provided on the other surface of the ring-shaped member main body 608a.

A protruding portion 307a capable of sliding on the flat surface 306c of the rotary plate 306 along the outer rim portion of the lower part is formed to the upper plate 307, and the upper plate 307 can move on the rotary plate 306 in the two-dimensional direction. Also, a concave portion 307b is formed at the central part on the lower surface of the upper plate 307, and a small opening 307c used to observe a sample is formed at the center of this concave portion 307b.

Moreover, as shown in FIG. 5D, the parallel guide grooves 307e along the horizontal direction of the page space with the concave portion 307b therebetween are provided to the upper plate 307 on the flat surface 307d between the protruding portion 307a and the rim of the concave portion 307b.

When such an upper plate 307 is arranged on the rotary plate 306, the four pins 610 provided on the other surface of the ring-shaped member main body 608a are inserted into the guide grooves 307e so that the entire upper plate 307 can linearly reciprocate along the guide groove 307e.

That is, in regard to the relationship between the rotary plate 306, the ring-shaped member 608 and the upper plate 307, the ring-shaped member 608 is provided to the rotary plate 306 so as to be capable of linearly reciprocating along only the guide grooves 306d, and the upper plate 307 can linearly reciprocate with respect to the ring-shaped member 608 in a direction orthogonal to the movement direction of the ring-shaped member 608 along the guide grooves 307e.

In the modification illustrated in FIGS. 5A to 5D, since the pins 609 and 610 are used in place of the guide members 309 and 310, it is possible to configure the present invention with a low cost.

Next, FIGS. 6A to 6E show a modification of the rotary plate 306, the upper plate 307, the ring-shaped member 308, a pair of the guide members 309 and a pair of the guide members 310.

As shown in FIG. 6A, a protruding wall 706b is formed to the rotary plate 706 along the outer rim portion of the upper surface thereof, and parallel guide grooves 706d along the vertical direction of the page space are provided on a flat surface lower than a flat surface 706c between the protruding wall 706b and the opening 706a by one stage on the both sides of the opening 706a. Since the guide grooves 706d are formed to be continuous from the opening 706a, one side thereof is divided into two parts in the vertical direction of the page space, and hence a total of four parts are provided on the both sides.

An upper plate 707 is arranged on the rotary plate 706 through a ring-shaped member 708 as a movement restricting member.

As shown in FIG. 6E, four shoulder pins 709 are press-fitted into the ring-shaped main body 708a from the lower surface of the ring-shaped main body 708.

As shown in FIG. 6C, the lower side 709a of each of the four shoulder pins 709 is inserted into each of the parallel guide grooves 706d of the rotary plate 706, and the ring-shaped member 708 can linearly reciprocate along the guide grooves 706d in this state.

The upper sides 709b of the four shoulder pins 709 are configured to be capable of being inserted into later-described parallel guide grooves 707e of the upper plate 707.

A protruding portion 707a capable of sliding on the flat surface 706c of the rotary plate 706 along the outer rim portion of the lower part is formed to the upper plate 707 so that the upper plate 707 can move on the rotary plate 706 in the two-dimensional direction. Also, a concave portion 707b is formed at the central part on the lower surface, and a small opening 707c used to observe a sample is formed at the center of the concave portion 707b.

In addition, as shown in FIG. 6D, parallel guide grooves 707e along the horizontal direction of the page space are provided to the upper plate 707 on a flat surface 707d between the protruding portion 707a and the rim of the concave portion 707b with the concave portion 707b therebetween. One side of the guide grooves 707e is divided into two positions in the right-and-left direction of the page space, and thereby four grooves are provided on the both sides thereof.

With such an upper plate 707 being arranged on the rotary plate 706, the upper sides 709b of the four pins 709 provided to the ring-shaped portion main body 708a are inserted into the guide grooves 707e, and the entire upper plate 707 can thus linearly reciprocate along the guide grooves 707e.

That is, in regard to the relationship between the rotary plate 706, the ring-shaped member 708 and the upper plate 707, the ring-shaped member 708 is provided to the rotary plate 706 so as to be capable of linearly reciprocating along only the guide grooves 706d, and the upper plate 707 can linearly reciprocate with respect to the ring-shaped member 708 in a direction orthogonal to the movement direction of the ring-shaped member 708 along the guide grooves 707e.

In the modification shown in FIGS. 6A to 6E, since the four shoulder pins 709 are used in place of the guide grooves 309 and 310, the present invention can be configured with a lower cost than that of the modification illustrated in FIGS. 5A to 5E.

Besides, as a method of restricting movement of the upper plate, any method can be employed, and it is good enough to adopt a configuration such that the upper plate moves in a direction of substantially vertical two axes (e.g., the above-described XY direction) in a plane vertical to the optical axis of the objective lens.

(Second Embodiment)

A second embodiment according to the present invention will now be described.

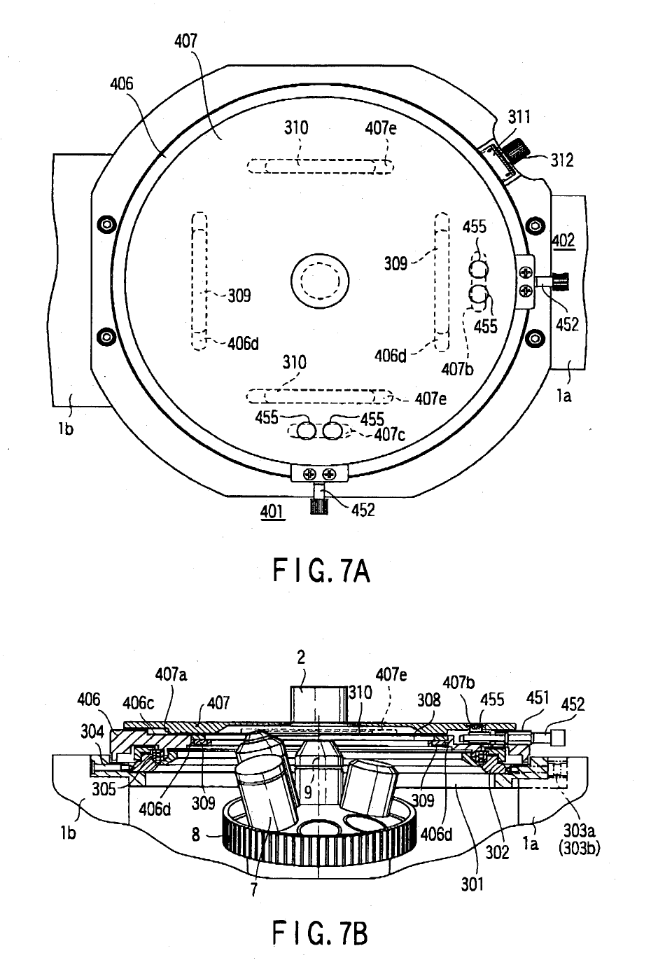

FIGS. 7A and 7B are views showing a schematic configuration of a microscope stage 3 to which the present invention is applied. FIG. 7A is a view showing the microscope stage 3 from the upper surface, and FIG. 7B is a sectional side view of the microscope stage 3.

It is to be noted that, in FIGS. 7A and 7B, the stage receiver 301, the substrate 302, the centering screws 303a and 303b, the plunger 304, the radial bearing 305, the ring-shaped member 308 and the guide members 309 and 310 provided to the ring-shaped member 308 are equal to those in the first embodiment, thereby omitting their explanation.

In this case, a rotary plate 406 is likewise provided to the substrate 302 through the radial bearing 305. This rotary plate 406 is supported to be rotatable around the center of the substrate 302.

An upper plate 407 is arranged on the rotary plate 406 through the ring-shaped member 308. When a protruding portion 407a formed along the outer rim portion on the lower surface of the upper plate 407 is slid on a flat surface 406c on the rotary plate 406, the upper plate 407 is subjected to two-dimensional positional adjustment in a plane orthogonal to the optical axis of the objective lens 7. Additionally, when a pair of the guide members 309 provided in parallel with each other on one surface of the ring-shaped member 308 are inserted into guide grooves 406d provided to the rotary plate 406, the ring-shaped member 308 can move in a direction vertical to the page space. Further, when a pair of the guide members 310 attached in parallel with each other on the other surface of the ring-shaped member 308 are inserted into guide grooves 407e provided to the upper plate 407, the upper plate 407 can move with respect to the ring-shaped member 308 in the right-and-left direction of the page space.

As a result, like the first embodiment, the upper plate 407 can two-dimensionally move in a plane orthogonal to the optical axis 9 of the objective lens 7 while maintaining the same angle relative to the rotary plate 406. In this case, a lubricant such as a grease is applied between the flat surface 406c of the rotary plate and the protruding portion 407a of the upper plate 407 slid on the flat surface 406c, and the upper plate 407 can be slid with an appropriate amount of force, which is the same as the first embodiment.

To the upper plate 407 are formed a long groove 407b extending in parallel to the movement direction (i.e., a direction vertical to the page space) of the guide members 309 of the ring-shaped member 308, and a long groove 407c extending in parallel to the movement direction (i.e., a right-and-left direction of the page space) of the guide members 310 of the ring-shaped member 308.

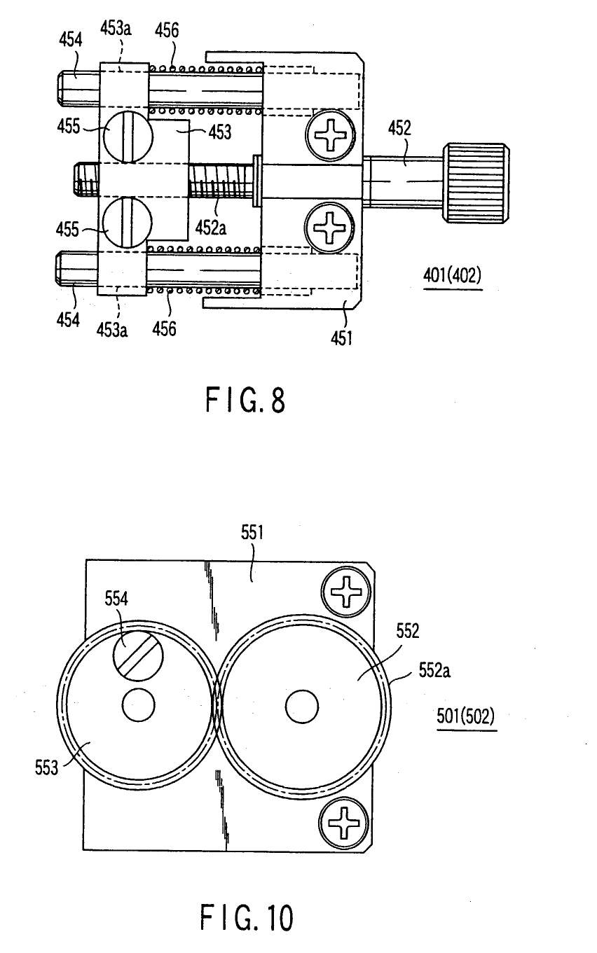

First and second driving mechanisms 401 and 402 used to drive the upper plate 407 in two directions orthogonal to each other are attached to the rotary plate 406 in a plane orthogonal to the optical axis 9 of the objective lens 7. Of these mechanisms, the first driving mechanism 401 drives the upper plate 407 in the movement direction of the guide members 309, and the second driving mechanism 402 drives the upper plate 407 in the movement direction of the guide members 310. Since the first and second driving mechanisms 401 and 402 have the same configuration, they will be explained with reference to FIG. 8.

In FIG. 8, reference numeral 451 denotes a fixed block fixed on the rotary plate 406, and a feed knob 452 is supported by the fixed block 451 to be rotatable but not to move in the axial direction. A lead screw portion 452a is provided to this feed knob 452.

A movable block 453 driven in one direction with respect to the fixed block 451 is provided to the lead screw portion 452a of the feed knob 452, and the movable block 453 is driven to linearly reciprocate by rotation of the feed knob 452.

A pair of guide pins 454 which are arranged at symmetrical positions on the both sides of the lead screw portion 452a are fixed to the fixed block 451. These guide pins 454 enable linear movement of the entire movable block 453 without rotating when the feed knob 452 is rotated, and they are inserted into guide holes 453a provided to the movable block 453. In this case, the arrangement direction of the guide pins 454 correctly matches with the axial direction of the lead screw portion 452a. Further, compression coil springs 456 which acts between the fixed block 451 and the movable block 453 in the stretching direction (extending direction) are provided to the guide pins 454. The compression coil springs 456 are used for the purpose of suppressing jouncing at the lead screw portion 452a provided to the feed knob 452. It is to be noted that the compression coil springs 456 acting in the extending direction are used in this embodiment but helical extension springs acting in the opposite direction may be adopted.

Two engagement pins 455 are erected on the movable block 453. These engagement pins 455 engage with the long groove 407b (or the long groove 407c) provided to the upper plate 407.

In such a configuration, the two engagement pins 455 provided to the movable block 453 engage with the long groove 407c provided to the upper plate 407 in the first driving mechanism 401, and the two engagement pins 455 provided to the movable block 453 engage with the long groove 407b provided to the upper plate 407 in the second driving mechanism 402.

When the feed knob 452 of the second driving mechanism 402 is rotated in this state, the movable block 453 is driven in the right-and-left direction of the page space, and the driving force in the right-and-left direction of the page space is transmitted to the upper plate 407 engaged with the two engagement pin 455 fixed to the movable block 453 in the long groove 407b.

In this case, since the direction of the two guide grooves 407e provided to the upper plate 407 is completely the same as the driving direction of the movable block 453, only the upper plate 407 is driven in the right-and-left direction of the page space when the feed knob 452 is rotated, and the ring-shaped member 308 is not driven but remains still with respect to the rotary plate 406.

At this moment, since the long groove 407b of the upper plate 407 engaging with the two engagement pins 455 of the first driving mechanism 401 is arranged in completely the same direction as that of the lead screw portion 452a of the feed knob 452 of the second driving mechanism 402, the two engagement pins 455 of the first driving mechanism 401 and the long groove 407c of the upper plate 407 do not function as obstacles when moving the upper plate 407 in the right-and-left direction of the page space by rotating the feed knob 452 of the second driving mechanism 402, thereby enabling the smooth drive operation.

Then, when the feed knob 452 of the first driving mechanism 401 is rotated, the movable block 453 is driven in the direction vertical to the page space in FIG. 7B, and the driving force in the vertical direction of the page space in FIG. 7B is transmitted to the upper plate 407 engaged with the two engagement pins 455 fixed to the movable block 453 in the long groove 407c.

In this case, since the direction of the two guide grooves 407e provided to the upper plate 407 is orthogonal to the driving direction of the movable block 453, the ring-shaped member 308 is driven in the vertical direction of the page space together with the upper plate 407 as well as the guide members 310 on the ring-shaped member 308 side inserted into the two guide grooves 407e of the upper plate 407.

At that time, since the long groove 407b of the upper plate 407 engaging with the two engagement pins 455 of the second driving mechanism 402 is arranged in completely the same direction as the lead screw portion 452a of the feed knob 452 of the first driving mechanism 401, the two engagement pins 455 of the second driving mechanism 402 and the long groove 407b of the upper plate 407 do not serve as obstacles when moving the upper plate 407 in the vertical direction of the page space in FIG. 7B by rotating the feed knob 452 of the first driving mechanism 401, thereby enabling the smooth driving operation.

Therefore, with such a configuration, when adjusting the observation position of the observation sample 2, movement of the upper plate 407 is adjusted independently in directions orthogonal to each other by the first driving mechanism 401 and the second driving mechanism 402, and the driving mechanism having the lead screw portion 452a is adopted as the first and second driving mechanisms 401 and 402. Therefore, the upper plate can be precisely and smoothly fed by the feed knob 452, and the operation to move a target position of the observation sample to the center of the observation field can be very easily performed even in observation using the objective lens with a high magnification.

(Third Embodiment)

A third embodiment according to the present invention will now be described.

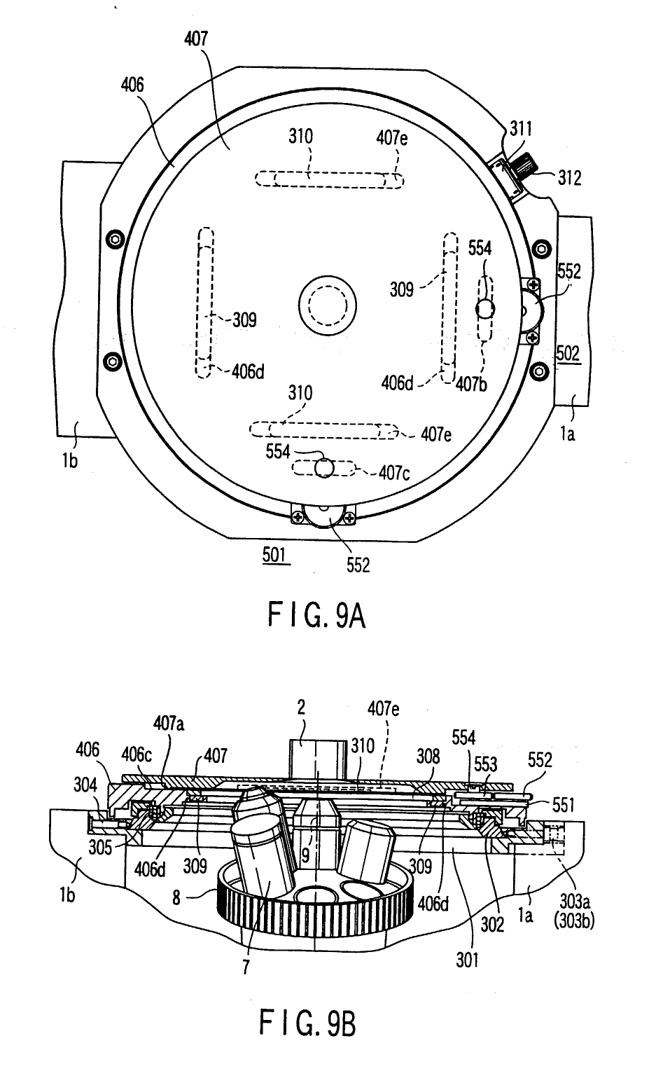

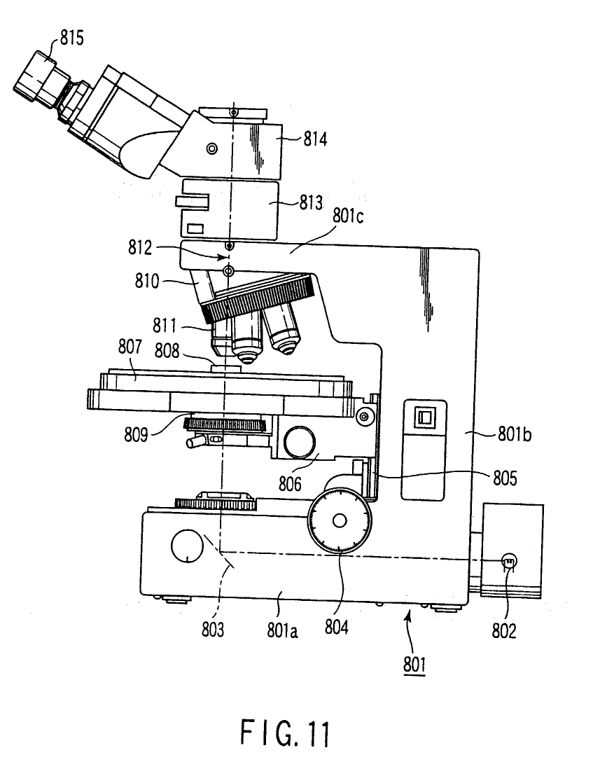

FIGS. 9A and 9B show a schematic configuration of a microscope stage 3 to which the present invention is applied. FIG. 9A is a view showing the microscope stage 3 from the upper surface, and FIG. 9B is a sectional side view of the microscope stage 3.

In this case, in the third embodiment, only the first and second driving mechanisms 501 and 502 which drive the upper plate 407 are different from the second embodiment, and other members, i.e., the stage receiver 301, the substrate 302, the centering screws 303a and 303b, the plunger 304, the radial bearing 305, the rotary plate 406, the upper plate 407, the ring-shaped member 308, and the guide members 309 and 310 provided to the ring-shaped member 308 are equal to those in the second embodiment, thereby omitting their explanation.

In this case, first and second driving mechanisms 501 and 502 used to drive the upper plate 407 in two directions orthogonal to each other are likewise attached to the rotary plate 406. Of these mechanisms, the first driving mechanism 501 drives the upper plate 407 in the movement direction of the guide members 309, and the second driving mechanism 502 drives the upper plate 407 in the movement direction of the guide members 310. The first and second driving mechanisms 501 and 502 have the same configuration, and hence they will be described with reference to FIG. 10.

In FIG. 10, an operation dial 552 is rotatably provided on a fixed block 551 fixed on the rotary plate 406. A gear 552a is provided to the operation dial 552 along the outer rim portion thereof.

Further, a driving gear 553 as a rotary member is rotatably provided on the fixed block 551. The driving gear 553 meshes with the gear 552 of the operation dial 552. When the operation dial 552 is rotated, the driving gear 553 rotates in accordance with this rotation. Furthermore, a driving pin 554 is provided to the driving gear 553 at a position eccentric from the center of rotation. This driving pin 554 is engaged with the long groove 407b (or the long groove 407c) provided to the upper plate 407.

In such a configuration, the driving pin 554 provided to the driving gear 553 is engaged with the long groove 407c provided to the upper plate 407 in the first driving mechanism 501, and the driving pin 554 provided to the driving gear 553 is engaged with the long groove 407b provided to the upper plate 407 in the second driving mechanism 502.

Then, when the operation dial 552 of the first and second driving mechanisms 501 and 502 is rotated in this state, the driving force is transmitted to the upper plate 407 through the long grooves 407c and 407b provided to the upper plate 407 by the driving pin 554. At that time, since the driving pin 554 draws an arc, the long grooves 407b and 407c of the upper plate 407 receive a small force in the direction of the groove side edge by the contact friction with the driving pin 554. However, since the frictional force is small, the driving force of the upper plate 407 caused by the driving pin 554 necessarily acts in the movement directions of the guide members 309 and 310 provided to the ring-shaped member 308.

For example, when the operation dial 552 of the second driving mechanism 502 is rotated, the driving force from the driving pin 554 acts so as to drive the upper plate 407 in the movement direction (i.e., the right-and-left direction of the page space) of the guide members 310. In this case, although the force which tries to move the upper plate 407 in the vertical direction of the page space in FIG. 9B by the frictional force with the side edge portion of the long groove 407b generated by rotation of the driving pin 554, the force obtained at this moment does not have a magnitude to move the guide members 309 with respect to the rotary plate 406 in the vertical direction of the page space in FIG. 9B, and hence the upper plate 407 is driven only in the movement direction of the guide members 310.

Likewise, when the operation dial 552 of the first driving mechanism 501 is rotated, the driving force from the driving pin 554 acts so as to drive the upper plate 407 in the movement direction (i.e., the vertical direction of the page space in FIG. 9B) of the guide members 309.

Therefore, the operation like that in the second embodiment can be obtained by the above-described configuration, and the upper plate 407 can be driven independently in two directions orthogonal to each other with a configuration simpler than the first and second driving mechanisms 401 and 402 in the second embodiment, thereby reducing the cost of the microscope stage as a total.

It is to be noted that description has been given as to the case that the present invention is applied to the inverted metallographical microscope in the foregoing embodiments, but the present invention can be likewise applied to an microscope with upright frame.

FIG. 11 is a view showing a schematic configuration when the stage in the first to third embodiments is applied to the microscope with upright frame.

Here, a later-described stage receiver 806 is used in place of the stage receiver 301 which is utilized when the present invention is applied to the inverted metallographical microscope shown in FIG. 1. a part of the microscope stage excluding the stage receiver is the same as the microscope stage 3 illustrated in FIGS. 1 and 2.

In FIG. 11, reference numeral 801 denotes a microscope main body (main body), and reference numeral 802 designates a transmitted illumination light source such as a halogen lamp or mercury. A light flux from the transmitted illumination light source 802 passes through a base part 801a of the main body 801 and is deflected upwards in the vertical direction by a folded mirror 803 contained the base part 801a.

A sighting guide 805 which is driven to move up and down by a sighting handle 804 is provided to a vertical portion 801b of the main body, and a microscope stage 807 is attached to the sighting guide 805 through a stage receiver 806. An observation sample 808 is mounted on the microscope stage 807.

A condensing lens 809 is attached at a lower end of the stage receiver 806, and the transmitted illumination light flux which is upward in the vertical direction is condensed on and illuminates the observation sample 808.

On the other hand, a revolver 810 is attached at an arm end 801c of the main body 801, one objective lens 811 in a plurality of objective lenses in the revolver 810 is selectively arranged on a optical axis 812. Reference numeral 813 denotes a polarization observation intermediate tube attached on the arm end 801c; reference numeral 814, a body tube attached on the polarization observation intermediate tube 813; and reference numeral 815, an eyepiece attached to the body tube 814.

The light flux from the observation sample 808 becomes a parallel light flux after entering the objective lens 811, and is image-formed on a focusing surface of the eyepiece 815 by a non-illustrating image forming lens contained in the body tube 814. Then, it reaches eyes of an observer, and is observed by the observer.

Further, description has been separately given as to the example in which the first driving mechanism and the second driving mechanism are attached on the rotary plate and the example in which these mechanisms are not attached in the foregoing embodiments. However, in the example in which the first driving mechanism and the second driving mechanism are attached, the observation sample mounted on the upper plate can be moved by directly touching and operating the upper plate if the first driving mechanism and the second driving mechanism are removed in accordance with a preference of a user. These two states can be readily selected in accordance with a preference of a user. Furthermore, although the guide members are provided as the movement restricting members to the ring-shaped member in the foregoing embodiments, respective convex guide portions may be provided to the rotary plate and the upper plate, and guide grooves may be formed to the ring-shaped member.

Furthermore, the radial bearing 305 is used in order to rotate the rotary plate in the foregoing embodiments, but sliding may be caused between the substrate 302 and the rotary plate 306, 406 or 706. In this case, smooth rotation is enabled by applying a lubricant such as a grease between them.

The following invention can be extracted from the above respective embodiments.

A microscope stage according to a first aspect of the present invention is characterized by comprising: a substrate whose position is adjustable in a plane orthogonal to a optical axis of an objective lens; an upper plate which mounts an observation sample and is movable in a two-dimensional direction on the substrate; and a movement restricting member which is provided between the substrate and the upper plate and restricts movement of the upper plate to two directions on a plane orthogonal to the optical axis of the objective lens.

In the first aspect, the following modes are preferable.

(1) The movement restricting member restricts the movement of the upper plate to a first direction on the plane and a second direction which is on the plane and substantially orthogonal to the first direction.

(2) A first driving mechanism which linearly moves the upper plate in the plane orthogonal to the optical axis of the objective lens; and a second driving mechanism which linearly moves the upper plate in a direction orthogonal to the linear movement direction of the upper plate by the first driving mechanism are further provided.

(3) In (2), the first driving mechanism and the second driving mechanism each comprises: a fixed block; and a movable body which is linearly movable with respect to the fixed block, and the upper plate is linearly moved in accordance with the movement of the movable body.

(4) In (21), the first driving mechanism and the second driving mechanism each comprises: a fixed block; a rotary member which is rotatable with respect to the fixed block; and a driving pin provided at a position eccentric from a center of rotation of the rotary member, and the upper plate is linearly moved in accordance with movement of the driving pin involved by rotation of the rotary member.

(5) A rotary plate which is rotatable with the optical axis of the objective lens at the center of rotation is further provided.

(6) In (5), the rotary plate comprises: a first driving mechanism which linearly moves the upper plate in a plane orthogonal to the optical axis of the objective lens; and a second driving mechanism which linearly moves the upper plate in a direction orthogonal to the linear movement direction of the upper plate by the first driving mechanism.

(7) In (6), the first driving mechanism and the second driving mechanism each comprises: a fixed block fixed to the rotary plate; and a movable body which is linearly movable with respect to the fixed block, and the upper plate is linearly moved in accordance with movement of the movable body.

(8) In (6), the first driving mechanism and the second driving mechanism each comprises: a fixed block fixed to the rotary plate; a rotary member which is rotatable with respect to the fixed block; and a driving pin provided at a position eccentric from a center of rotation of the rotary member, and the upper plate is linearly moved in accordance with the movement of the driving pin involved by rotation of the rotary member.

(9) In (5), the substrate has a clamp mechanism which restricts rotation of the rotary plate.

A microscope stage according to a first aspect of the present invention is characterized by comprising: a substrate whose position is adjustable in a plane orthogonal to a optical axis of an objective lens; a rotary plate which is rotatable with the optical axis of the objective lens at the center of rotation; an upper plate which mounts an observation sample and is movable on the rotary plate in a two-dimensional direction; and a movement restricting member which is provided between the rotary plate and the upper plate and restricts movement of the upper plate to two directions on the plane orthogonal to the optical axis of the objective lens.

In the second aspect, the following modes are preferable.

(1) The movement restricting member restricts the movement of the upper plate to a first direction on the plane and a second direction which is on the plane and substantially orthogonal to the first direction.

(2) A first driving mechanism which linearly moves the upper plate in a plane orthogonal to the optical axis of the objective lens; and a second driving mechanism which linearly moves the upper plate in a direction orthogonal to the linear movement direction of the upper plate by the first driving mechanism are further provided.

(3) In (2), the rotary plate comprises both of the first driving mechanism and the second driving mechanism.

(4) In (3), the first driving mechanism and the second driving mechanism each comprises: a fixed block fixed to the rotary plate; and a movable body which is linearly movable with respect to the fixed block, and the upper plate is linearly moved in accordance with movement of the movable body.

(5) In (3), the first driving mechanism and the second driving mechanism each comprises: a fixed block fixed to the rotary plate; a rotary member which is rotatable with respect to the fixed block; and a driving pin provided at a position eccentric from a center of rotation of the rotary member, and the upper plate is linearly moved in accordance with movement of the driving pin involved by rotation of the rotary member.

(6) The substrate has a clamp mechanism which restricts rotation of the rotary plate.

A microscope according to a third aspect of the present invention is characterized by comprising a microscope stage, the microscope stage comprising: a substrate whose position is adjustable in a plane orthogonal to a optical axis of an objective lens; an upper plate which mounts an observation sample and is movable on the substrate in a two-dimensional direction; and a movement restricting member which is provided between the substrate and the upper plate and restricts movement of the upper plate to two directions on the plane orthogonal to the optical axis of the objective lens.

A microscope according to a fourth aspect of the present invention is characterized by comprising a microscope stage, the microscope stage comprising: a substrate whose position is adjustable in a plane orthogonal to a optical axis of an objective lens; a rotary plate which is rotatably provided with the optical axis of the objective lens at the center of rotation; an upper plate which mounts an observation sample and is movable on the rotary plate in a two-dimensional direction; and a movement restricting member which is provided between the rotary plate and the upper plate and restricts movement of the upper plate to two directions on the plane orthogonal to the optical axis of the objective lens.

As a result, according to the microscope stage of the present invention, an angle of the observation sample relative to the microscope optical system can be set by rotating the rotary plate, and the upper plate can be moved while maintaining the angle set by the rotary plate, thereby readily moving a desired position to be observed in the observation sample into the observation field.

Moreover, according to the microscope stage of the present invention, when adjusting an observation position of the observation sample, movement of the upper plate can be adjusted independently in directions orthogonal to each other by the first driving mechanism and the second driving mechanism. In this case, the upper plate can be precisely and smoothly fed in accordance with an amount of linear movement of the movable body provided in the fixed block and an amount of rotation of the rotary members.

In addition, according to the microscope stage of the present invention, since the clamp mechanism which fixes the rotary plate so as not to rotate with respect to the substrate is provided, the rotary plate can be fixed in such a manner that an angle of the observation sample is not accidentally changed, and the upper plate can be then moved with respect to the rotary plate.

Additionally, according to the microscope of the present invention on which the microscope stage is mounted, a stable observation image which hardly causes a partial blur can be obtained even if the observation sample is a constitution sample or a large sample with a great mass, and the microscope stage has a compact configuration in which a space of the objective lens in the direction of the optical axis is minimized. Therefore, the microscope stage can be optimally incorporated in an inverted microscope having a large restriction in the dimension of the stage in the thickness direction. Further, since the large opening is provided at the center of the microscope stage, the microscope stage can be optimally incorporated and used in the inverted microscope which requires a large clearance at the central part of the stage when switching the objective lens.

Besides, the present invention is not restricted to the foregoing embodiments, and various modifications can be carried out on the embodying stage without departing from the scope of the invention.

Furthermore, the foregoing embodiments include the invention on various stages, and a variety of inventions can be extracted by appropriately combining a plurality of disclosed configuration requirements. For example, even if some configuration requirements are deleted from all the configuration requirements disclosed in the embodiments, the problems described in the section “problems to be solved by the invention” can be solved. When the effects described in the section “effects of the invention” can be obtained, the configuration in which these configuration requirements are deleted can be extracted as the invention.

As described above, according to the present invention, it is possible to provide a microscope stage which can obtain a stable observation image which hardly causes a partial blur irrespective of the microscope with upright frame and the inverted microscope even if the observation sample is a constitution sample or a large sample with a great mass, has a compact shape that it can be incorporated in the inverted microscope requiring a large opening space on the lower surface of the stage, and can move an arbitrary position of the observation sample to the vicinity of the center of rotation, and also provide a microscope having this microscope stage mounted thereon.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A microscope stage comprising:
a substrate whose position is adjustable in a plane orthogonal to a optical axis of an objective lens;
an upper plate which mounts an observation sample and is movable in a two-dimensional direction on the substrate; and
a movement restricting member which is provided between the substrate and the upper plate and restricts movement of the upper plate to two directions on a plane orthogonal to the optical axis of the objective lens.

2. The microscope stage according to claim 1, wherein the movement restricting member restricts the movement of the upper plate to a first direction on the plane and a second direction which is on the plane and substantially orthogonal to the first direction.

3. The microscope stage according to claim 1, further comprising:
a first driving mechanism which linearly moves the upper plate in the plane orthogonal to the optical axis of the objective lens; and
a second driving mechanism which linearly moves the upper plate in a direction orthogonal to the linear movement direction of the upper plate by the first driving mechanism.

4. The microscope stage according to claim 3, wherein the first driving mechanism and the second driving mechanism each comprises:
a fixed block; and
a movable body which is linearly movable with respect to the fixed block, and
the upper plate is linearly moved in accordance with the movement of the movable body.

5. The microscope stage according to claim 3, wherein the first driving mechanism and the second driving mechanism each comprises:
a fixed block;
a rotary member which is rotatable with respect to the fixed block; and
a driving pin provided at a position eccentric from a center of rotation of the rotary member, and
the upper plate is linearly moved in accordance with movement of the driving pin involved by rotation of the rotary member.

6. The microscope stage according to claim 1, further comprising a rotary plate which is rotatable with the optical axis of the objective lens at the center of rotation.

7. The microscope stage according to claim 6, wherein the rotary plate comprises:
a first driving mechanism which linearly moves the upper plate in a plane orthogonal to the optical axis of the objective lens; and
a second driving mechanism which linearly moves the upper plate in a direction orthogonal to the linear movement direction of the upper plate by the first driving mechanism.

8. The microscope stage according to claim 7, wherein the first driving mechanism and the second driving mechanism each comprises:
a fixed block fixed to the rotary plate; and
a movable body which is linearly movable with respect to the fixed block, and
the upper plate is linearly moved in accordance with movement of the movable body.

9. The microscope stage according to claim 7, wherein the first driving mechanism and the second driving mechanism each comprises:
a fixed block fixed to the rotary plate;
a rotary member which is rotatable with respect to the fixed block; and
a driving pin provided at a position eccentric from a center of rotation of the rotary member, and
the upper plate is linearly moved in accordance with the movement of the driving pin involved by rotation of the rotary member.

10. The microscope stage according to claim 6, wherein the substrate has a clamp mechanism which restricts rotation of the rotary plate.

11. A microscope stage comprising:
a substrate whose position is adjustable in a plane orthogonal to a optical axis of an objective lens;
a rotary plate which is rotatable with the optical axis of the objective lens at the center of rotation;
an upper plate which mounts an observation sample and is movable on the rotary plate in a two-dimensional direction; and
a movement restricting member which is provided between the rotary plate and the upper plate and restricts movement of the upper plate to two directions on the plane orthogonal to the optical axis of the objective lens.

12. The microscope stage according to claim 11, wherein the movement restricting member restricts the movement of the upper plate to a first direction on the plane and a second direction which is on the plane and substantially orthogonal to the first direction.

13. The microscope stage according to claim 11, further comprising:
a first driving mechanism which linearly moves the upper plate in a plane orthogonal to the optical axis of the objective lens; and
a second driving mechanism which linearly moves the upper plate in a direction orthogonal to the linear movement direction of the upper plate by the first driving mechanism.

14. The microscope stage according to claim 13, wherein the rotary plate comprises both of the first driving mechanism and the second driving mechanism.

15. The microscope stage according to claim 14, wherein the first driving mechanism and the second driving mechanism each comprises:
a fixed block fixed to the rotary plate; and
a movable body which is linearly movable with respect to the fixed block, and
the upper plate is linearly moved in accordance with movement of the movable body.

16. The microscope stage according to claim 14, wherein the first driving mechanism and the second driving mechanism each comprises:
a fixed block fixed to the rotary plate;
a rotary member which is rotatable with respect to the fixed block; and
a driving pin provided at a position eccentric from a center of rotation of the rotary member, and
the upper plate is linearly moved in accordance with movement of the driving pin involved by rotation of the rotary member.

17. The microscope stage according to claim 11, wherein the substrate has a clamp mechanism which restricts rotation of the rotary plate.

18. A microscope comprising a microscope stage, the microscope stage comprising: a substrate whose position is adjustable in a plane orthogonal to a optical axis of an objective lens; an upper plate which mounts an observation sample and is movable on the substrate in a two-dimensional direction; and a movement restricting member which is provided between the substrate and the upper plate and restricts movement of the upper plate to two directions on the plane orthogonal to the optical axis of the objective lens.

19. A microscope comprising a microscope stage, the microscope stage comprising: a substrate whose position is adjustable in a plane orthogonal to a optical axis of an objective lens; a rotary plate which is rotatably provided with the optical axis of the objective lens at the center of rotation; an upper plate which mounts an observation sample and is movable on the rotary plate in a two-dimensional direction; and a movement restricting member which is provided between the rotary plate and the upper plate and restricts movement of the upper plate to two directions on the plane orthogonal to the optical axis of the objective lens.
